(19) United States
(12) Patent Application Publication
(10) Pub. No.: US 2024/0150648 A1
(43) Pub. Date: May 9, 2024

(54) MULTIPLE PHOTOLUMINESCENT PEROVSKITE QUANTUM DOTS DOPED WITH RARE EARTH ION PAIRS AND METHODS FOR PREPARING THE SAME

(71) Applicant: Industry-Academic Cooperation Foundation, Yonsei University, Seoul (KR)

(72) Inventors: Jiwon KIM, Seoul (KR); Jiyeon LEE, Incheon (KR); Jaehyeok RYU, Gyeonggi-do (KR); Dongjun KIM, Incheon (KR); Seoyeah OH, Gyeonggi-do (KR); Jihyeon PARK, Incheon (KR); Geonho KIM, Jeollabuk-do (KR); Seoyoung YOON, Incheon (KR); Hyunbin PARK, Incheon (KR)

(73) Assignee: Industry-Academic Cooperation Foundation, Yonsei University, Seoul (KR)

(21) Appl. No.: 18/505,202

(22) Filed: Nov. 9, 2023

(30) Foreign Application Priority Data
Nov. 9, 2022 (KR) 10-2022-0148942
Nov. 6, 2023 (KR) 10-2023-0151589

(51) Int. Cl. C09K 11/77; C09K 11/61; C09K 11/66

(52) U.S. Cl. CPC C09K 11/7766; C09K 11/61; C09K 11/66; C09K 2211/182; C09K 2211/188

(57) ABSTRACT

Provided are perovskite quantum dots showing an independent photoreaction to light stimulation in different wavelength bands from each other, a method for preparing the perovskite quantum dots, and an anti-counterfeiting ink including the perovskite quantum dots.

### CROSS-REFERENCE TO RELATED APPLICATIONS

This application claims priority to and the benefit of Korean Patent Application No. 10-2022-0148942, filed on Nov. 9, 2022, and Korean Patent Application No. 10-2023-0151589, filled on Nov. 6, 2023, which are incorporated herein by reference in their entirety.

### TECHNICAL FIELD

The following disclosure relates to perovskite quantum dots showing an independent photoreaction to light stimulation in different wavelength bands from each other, a method for preparing the perovskite quantum dots, and an anti-counterfeiting ink including the perovskite quantum dots.

### BACKGROUND

The statements in this section merely provide background information related to the present disclosure and may not constitute prior art.

Quantum dots are a material in the spotlight, since their size may be adjusted to simply adjust a luminescence wavelength band and their synthesis cost is low. In particular, organic/inorganic hybrid perovskite quantum dots have been attracting attention recently due to their high photoluminescence peak and a narrow full width at half maximum of the photoluminescence peak.

Meanwhile, upconversion photoluminescence (UCPL) is a phenomenon in which a specific rare earth metal is bonded to an inorganic host material to absorb many photons of low energy, that is, a long wavelength and emit photons of high energy, that is, a short wavelength, which is a phenomenon shown by interaction of the host material and the rare earth metal. The upconversion photoluminescence has attracted constant attention in various application fields, for example, infrared light is converted into visible light to increase solar battery efficiency or infrared light having high biopermeability is converted into visible light inside a biological tissue to give light stimulation, using the upconversion photoluminescence.

The upconversion photoluminescence of the rare earth element and the photoluminescence of the perovskite quantum dot are technologies having high industrial applicability, respectively, and the technologies may be converged to manufacture a drive device which reacts in various lights.

The above information discloses in this Background section is only for enhancement of understanding of the background of the present disclosure, and therefore it may contain information that does not form the prior art that is already known to a person of ordinary skill in the art.

### SUMMARY

An embodiment of the present invention is directed to providing multiple photoluminescence perovskite quantum dots which independently control photoluminescence reacting to lights in different wavelength bands, and a method for preparing the same.

Another embodiment of the present invention is directed to providing an anti-counterfeiting ink for preventing counterfeiting of banknotes, securities, and the like.

In one general aspect, a perovskite nanocrystal is provided, wherein the perovskite nanocrystal satisfying the following Chemical Formula 1 is doped by substituting a part of a B atom in Chemical Formula 1 with one or more divalent or trivalent cations selected from the group consisting of rare earth elements, and the perovskite nanocrystal shows both upconversion photoluminescence and photoluminescence:

ABX₃ (Chemical Formula 1)
wherein A is one or more selected from the group consisting of monovalent alkylammonium-based cations; monovalent amidinium-based cations; Li⁺; Na⁺; K⁺; Rb⁺; Cs⁺; Fr⁺; Cu(I)⁺; Ag(I)⁺; Au(I)⁺; and a combination thereof, B is a divalent metal cation, and X is a halogen anion which is I⁻, Br⁻, Cl⁻, or a combination thereof.

In the perovskite nanocrystal according to the present invention, the rare earth element may be one or more selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

In the perovskite nanocrystal according to the present invention, the substituted and doped rare earth element may include ytterbium trivalent cation (Yb³⁺) and erbium trivalent cation (Er³⁺).

In the perovskite nanocrystal according to the present invention, the B atom in Chemical Formula 1 included in the perovskite nanocrystal may be a lead cation (Pb²⁺).

In the perovskite nanocrystal according to the present invention, the photoluminescence may have a luminescence peak in a wavelength band of 420 to 470 nm, when a wavelength of incident light is 365±10 nm.

In the perovskite nanocrystal according to the present invention, the upconversion photoluminescence may have a luminescence peak in a wavelength band of 520 to 580 nm, when a wavelength of incident light is 980±10 nm.

In the perovskite nanocrystal according to the present invention, full widths at half maximum (FWHM) of luminescence peaks of the photoluminescence and the upconversion photoluminescence may be independently of each other 10 to 20 nm.

In the perovskite nanocrystal according to the present invention, a doping concentration may be 3% to 9% of the rare earth element, based on the total number of B atoms per lattice of the perovskite nanocrystal.

In the perovskite nanocrystal according to the present invention, a ratio between the ytterbium (Yb³⁺) and the erbium (Er³⁺) included in the perovskite nanocrystal may be 3:7 to 7:3.

In another general aspect, a method for preparing a perovskite nanocrystal includes: (S1) adding a first perovskite precursor, a first rare earth salt, a second rare earth salt, and a ligand precursor to an organic solvent and mixing them; (S2) adding a second perovskite precursor to the organic solvent; and (S3) cooling the organic solvent to prepare a perovskite nanocrystal, wherein the first rare earth salt and the second rare earth salt independently of each other include rare earth elements which are the same or different from each other, and the organic solvents in (S1) and (S2) are independently of each other continuously heated to a certain temperature.

In the method for preparing a perovskite nanocrystal according to the present invention, a temperature of the organic solvent in (S1) and (S2) steps may be independently of each other 30 to 250° C.

In the method for preparing a perovskite nanocrystal according to the present invention, the rare earth elements included in the first rare earth salt and the second rare earth salt may be independently of each other one or more selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

In the method for preparing a perovskite nanocrystal according to the present invention, the rare earth element included in the first rare earth salt may be ytterbium (Yb) and the rare earth element included in the second rare earth salt may be erbium (Er).

In the method for preparing a perovskite nanocrystal according to the present invention, the total number of moles of the rare earth elements included in the first rare earth salt and the second rare earth salt may be 3 to 9% of the number of moles of cations included in the first perovskite precursor.

In the method for preparing a perovskite nanocrystal according to the present invention, the first perovskite precursor may be a compound satisfying the following Chemical Formula 2:

BX₂ (Chemical Formula 2)
wherein B is a divalent metal cation, and X is a halogen anion which is I⁻, Br⁻, Cl⁻, or a combination thereof.

In the method for preparing a perovskite nanocrystal according to the present invention, B in Chemical Formula 2 may include lead (Pb).

In the method for preparing a perovskite nanocrystal according to the present invention, the second perovskite precursor may be a compound satisfying the following Chemical Formula 3:

AL (Chemical Formula 3)
wherein A is one or more monovalent cations selected from the group consisting of monovalent alkylammonium-based cations; monovalent amidinium-based cations; Li⁺; Na⁺; K⁺; Rb⁺; Cs⁺; Fr⁺; Cu(I)⁺; Ag(I)⁺; Au(I)⁺; and a combination thereof, and L is a monovalent anion including a carboxyl group and a carbon chain.

In the method for preparing a perovskite nanocrystal according to the present invention, A in Chemical Formula 3 may be a cesium (Cs) monovalent cation.

In the method for preparing a perovskite nanocrystal according to the present invention, L in Chemical Formula 3 may be an oleic acid monovalent anion.

In still another general aspect, an anti-counterfeiting ink includes the perovskite nanocrystal described above.

Other features and aspects will be apparent from the following detailed description, the drawings, and the claims. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a drawing schematizing an independent photoreaction of the present invention;

FIG. 2 is a drawing schematizing upconversion photoluminescence (UCPL) and photoluminescence (PL) mechanism according to an exemplary embodiment of the present invention;

FIG. 3 is drawings of photoluminescence of an anti-counterfeiting ink according to Example 1 after spin coating the anti-counterfeiting ink on a glass substrate having a size of 2.5 cm×2.5 cm, which were taken with an optical camera;

FIG. 4 is drawings showing a photoluminescence peak of photoluminescence of an anti-counterfeiting ink according to Example 1 after spin coating the anti-counterfeiting ink on a glass substrate having a size of 2.5 cm×2.5 cm;

FIG. 5 is a drawing showing a scattering peak occurring when a wavelength of incident light in the perovskite nanocrystal according to an exemplary embodiment of the present invention was adjusted to 900 nm, 940 nm, and 980 nm;

FIG. 6 is drawings of perovskite nanocrystals according to Example 1 (CsPbCl_{1.8}Br_{1.2}: Yb,Er), Comparative Example 1 (CsPbCl_{1.8}Br_{1.2}:Yb), and Comparative Example 2 (CsPbCl_{1.8}Br_{1.2}), which were taken using a transmission electron microscope (TEM);

FIG. 7 is a drawing showing the results of X-ray diffraction analysis of the perovskite nanocrystals according to Example 1 (CsPbCl_{1.8}Br_{1.2}: Yb,Er), Comparative Example 1 (CsPbCl_{1.8}Br_{1.2}:Yb), and Comparative Example 2 (CsPbCl_{1.8}Br_{1.2});

FIG. 8 is a drawing showing absorbance of the perovskite nanocrystals according to Example 1 (CsPbCl_{1.8}Br_{1.2}: Yb,Er), Comparative Example 1 (CsPbCl_{1.8}Br_{1.2}:Yb), and Comparative Example 2 (CsPbCl_{1.8}Br_{1.2}), measured using UV-Vis spectrophotometer;

FIG. 9 is a drawing showing luminescence peaks of the perovskite nanocrystals according to Example 1 (CsPbCl_{1.8}Br_{1.2}: Yb,Er), Comparative Example 1 (CsPbCl_{1.8}Br_{1.2}:Yb), and Comparative Example 2 (CsPbCl_{1.8}Br_{1.2}) measured under a light source at 365 nm;

FIG. 10 is a drawing showing luminescence peaks of the perovskite nanocrystals according to Example 1 (CsPbCl_{1.8}Br_{1.2}: Yb,Er), Comparative Example 1 (CsPbCl_{1.8}Br_{1.2}:Yb), and Comparative Example 2 (CsPbCl_{1.8}Br_{1.2}) measured under a light source at 980 nm; and

FIG. 11 is a drawing showing a measured luminescence peak of the nanocrystal according to Comparative Example 3 (NaYF₄:Yb, Er).

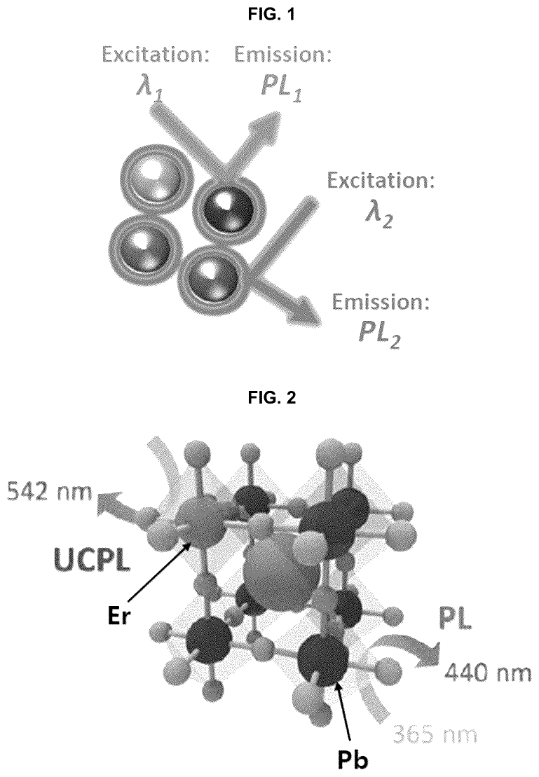

The drawings described herein are for illustration purposes only and are not intended to limit the scope of the present disclosure in any way.

### DETAILED DESCRIPTION OF EMBODIMENTS

The embodiments described in the present specification may be modified in many different forms, and the technology according to an exemplary embodiment is not limited to the embodiments set forth herein. In addition, the embodiments of an exemplary embodiment are provided so that the present disclosure will be described in more detail to a person with ordinary skill in the art. Technical terms and scientific terms used herein have the general meaning understood by those skilled in the art to which the present invention pertains unless otherwise defined, and a description for the known function and configuration which may unnecessarily obscure the gist of the present invention will be omitted in the following description and the accompanying drawings.

In addition, the singular form used in the present specification and the claims appended thereto may be intended to include a plural form also, unless otherwise indicated in the context.

In addition, in the present specification and the appended claims, the terms such as “first” and “second” are not used in a limited meaning but are used for the purpose of distinguishing one constituent element from other constituent elements.

In addition, in the present specification and the appended claims, when it is said that a part such as a film (layer), a domain, or a constituent element is positioned “on”, “in the upper portion”, “in the upper stage”, “under”, “in the lower portion”, or “in the lower stage”, it includes not only the case in which one part is in contact with the other part, but also the case in which there is another part between two parts.

In addition, the terms “about”, “substantially”, and the like used in the present specification and the appended claims are used in the meaning of the numerical value or in the meaning close to the numerical value when unique manufacture and material allowable errors are suggested in the mentioned meaning, and are used for preventing the disclosure mentioning a correct or absolute numerical value for better understanding of the present specification and the attached claims from being unfairly used by an unconscionable infringer.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms.

Furthermore, in the present specification and the appended claims, the terms such as “comprise” or “have” mean that there is a characteristic or a constituent element described in the specification, and as long as it is not particularly limited, a possibility of adding one or more other characteristics or constituent elements is not excluded in advance.

Hereinafter, a perovskite nanocrystal, a method for preparing a perovskite nanocrystal, and an anti-counterfeiting ink of the present invention will be described in detail.

The present invention provides a perovskite nanocrystal, wherein the perovskite nanocrystal satisfying the following Chemical Formula 1 is doped by substituting a part of a B atom in Chemical Formula 1 with one or more divalent or trivalent cations selected from the group consisting of rare earth elements, and the perovskite nanocrystal shows both upconversion photoluminescence and photoluminescence:

ABX₃ (Chemical Formula 1)
wherein A is one or more selected from the group consisting of monovalent alkylammonium-based cations; monovalent amidinium-based cations; Li⁺; Na⁺; K⁺; Rb⁺; Cs⁺; Fr⁺; Cu(I)⁺; Ag(I)⁺; Au(I)⁺; and a combination thereof, B is a divalent metal cation, and X is a halogen anion which is I⁻, Br⁻, Cl⁻, or a combination thereof.

The upconversion photoluminescence is an optical process of absorbing two or more low energy photons and emitting high energy photons. As a non-limiting example, the upconversion photoluminescence may be photoluminescence which absorbs light at a wavelength of 980 nm and emits light at 540 nm, but the present invention is not limited thereto, and the non-limiting example is only an example of the upconversion photoluminescence.

According to an exemplary embodiment, the perovskite crystal may be a crystal having a three-dimensional structure having a general formula such as Chemical Formula 1 or have a two-dimensional plane structure having a general formula of A₂BX₄, wherein an A atom is positioned at each vertex of the cubic unit lattice, a B atom is positioned at the body center, and an X atom is positioned at the face center.

According to an exemplary embodiment, the perovskite crystal may be doped by substituting a part of the B atom positioned in the body center of the perovskite crystal structure lattice with one or more divalent or trivalent cations selected from the group consisting of rare earth elements. The rare earth element may be one or more selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). As a favorable example, the rare earth element may be one or more trivalent cations selected from the group consisting of ytterbium (Yb) and erbium (Er), and more favorably, the rare earth element may include both an ytterbium trivalent cation (Yb³⁺) and an erbium trivalent cation (Er³⁺). Since the perovskite nanocrystal is doped by substituting a part of the B atom of the perovskite crystal according to Chemical Formula 1 with ytterbium and erbium, the ytterbium acts as a photosensitizer and the erbium acts as an emitter, so that the perovskite nanocrystal may have an upconversion photoluminescence characteristics, which is favorable.

According to an exemplary embodiment, the rare earth element included in the perovskite nanocrystal may be two or more. In order to perform the upconversion photoluminescence, a photosensitizer which absorbs light and an emitter which emits light may be needed, and two rare earth elements different from each other may act as the photosensitizer and the emitter to perform the upconversion photoluminescence.

According to an exemplary embodiment, the perovskite nanocrystal may perform the upconversion photoluminescence, and the upconversion photoluminescence may have a luminescence peak in a wavelength band of 520 to 580 nm when the wavelength of incident light is 980±10 nm. The upconversion photoluminescence may show a luminescence peak in a band of 510±10 nm, 520±10 nm, 530±10 nm, 540±10 nm, 550±10 nm, 560±10 nm, 570±10 nm, 580±10 nm, or 590±10 nm, when the wavelength of incident light is 980±10 nm. The luminescence peak of the upconversion photoluminescence may vary depending on the chemical species of the rare earth element included in the perovskite nanocrystal. As a non-limiting example, the perovskite nanocrystal may be doped with ytterbium (Yb) and erbium (Er) and perform the upconversion photoluminescence satisfying one wavelength band selected from the wavelength bands.

According to an exemplary embodiment, the photons of the incident light at a wavelength of 980±10 nm which is irradiated on the perovskite nanocrystal may be absorbed at ytterbium doped on the perovskite nanocrystal and then may be emitted at erbium doped on the perovskite nanocrystal by energy transfer.

According to an exemplary embodiment, the upconversion photoluminescence of the perovskite nanocrystal may have only one luminescence peak. Specifically, the upconversion photoluminescence shown by irradiating the perovskite nanocrystal with light does not have plural luminescence peaks but may have only one luminescence peak.

As a non-limiting example, an upconversion photoluminescence system including ytterbium (Yb) and erbium (Er) rare earth metals may have three luminescence peaks positioned at 522±10 nm, 542±10 nm, and 655±10 nm when generally incident light at a wavelength of 980±10 nm is irradiated, but the perovskite nanocrystal according to an exemplary embodiment of the present invention may have only one luminescence peak positioned at 542±10 nm when incident light at a wavelength of 980±10 nm is irradiated.

Herein, the upconversion photoluminescence having only one luminescence peak is a luminescence peak other than the photoluminescence peak occurring in the perovskite crystal, and the perovskite nanocrystal may perform both upconversion photoluminescence having only one luminescence peak and photoluminescence simultaneously.

According to an exemplary embodiment, a full width at half maximum (FWHM) of the luminescence peak of the upconversion photoluminescence may be 10 to 20 nm. The full width at half maximum of the luminescence peak of the upconversion photoluminescence may be 1 nm or more, 2 nm or more, 5 nm or more, or 10 nm or more, and as the upper limit, may be 50 nm or less, 40 nm or less, 30 nm or less, or 20 nm or less. Specifically, the full width at half maximum of the luminescence peak of the upconversion photoluminescence may be 1 to 50 nm, 2 to 40 nm, 5 to 30 nm, or 10 to 20 nm.

According to an exemplary embodiment, the photoluminescence may have a luminescence peak in a wavelength band of 420 to 470 nm, when a wavelength of incident light is 365±10 nm. The photoluminescence may show a luminescence peak in a band of 400±10 nm, 410±10 nm, 420±10 nm, 430±10 nm, 440±10 nm, 450±10 nm, 460±10 nm, 470±10 nm, 480±10 nm, 490±10 nm, or 500±10 nm, when the wavelength of incident light is 365±10 nm. The luminescence peak of the photoluminescence may vary depending on the chemical species of the monovalent cation (A), the divalent metal cation (B), and the halogen anion (X) included in the perovskite nanocrystal. As a non-limiting example, since the perovskite nanocrystal may include the perovskite crystal of CsPbCl_{1.8}Br_{1.2}, when light at 365±10 nm enters, a luminescence peak may be at 440±10 nm.

According to an exemplary embodiment, a full width at half maximum (FWHM) of the luminescence peak of the photoluminescence may be 10 to 20 nm. The full width at half maximum of the luminescence peak of the photoluminescence may be 1 nm or more, 2 nm or more, 5 nm or more, or 10 nm or more, and as the upper limit, may be 50 nm or less, 40 nm or less, 30 nm or less, or 20 nm or less. Specifically, the full width at half maximum of the luminescence peak of the photoluminescence may be 1 to 50 nm, 2 to 40 nm, 5 to 30 nm, or 10 to 20 nm.

According to an exemplary embodiment, a doping concentration of the rare earth element may be 3% to 9% of the atom of the rare earth element, based on the total number of B atoms per lattice of the perovskite nanocrystal. The perovskite nanocrystal may be a set of a lattice structure satisfying Chemical Formula 1. Herein, a part of the B atom in Chemical Formula 1 may be substituted with a rare earth element, and the rare earth element may be substituted for the B atom at a ratio of 1% or more, 2% or more, 3% or more, 4% or more, or 5% or more, and as the upper limit, may be substituted for the B atom at a ratio of 30% or less, 20% or less, 15% or less, 9% or less, or 7% or less, based on 100% of the total number of B atoms in Chemical Formula 1. Specifically, the rare earth element may be substituted for the B atom at a ratio of 1 to 30%, 2 to 20%, 3 to 15%, 4 to 9%, or 5 to 7%. The perovskite nanocrystal appropriately may contain the rare earth element in the range described above to perform the upconversion photoluminescence.

According to an exemplary embodiment, the rare earth element included in the perovskite nanocrystal includes ytterbium (Yb³⁺) and erbium (Er³⁺), and a ratio between the ytterbium (Yb³⁺) and erbium (Er³⁺) may be 3:7 to 7:3. As described above, the perovskite nanocrystal may include two or more rare earth elements different from each other. Herein, the two rare earth elements different from each other may behave as a photosensitizer and an emitter. As a non-limiting example, the two rare earth elements different from each other may be ytterbium (Yb³⁺) and erbium (Er³⁺), respectively, and the ytterbium may behave as a photosensitizer and the erbium may behave as an emitter. Herein, a ratio between ytterbium and erbium included in the perovskite nanocrystal may be 3:7, 4:6, 5:5, 6:4, or 7:3. As a favorable example, when a ratio between the ytterbium and the erbium, that is, the photosensitizer and the emitter, is 5:5, it may be advantageous for photon energy transfer of the upconversion photoluminescence of the perovskite nanocrystal, and it may be easy to adjust the characteristic of the upconversion photoluminescence.

According to an exemplary embodiment, a ratio between ytterbium (Yb³⁺) and erbium (Er³⁺) included in the perovskite nanocrystal may be adjusted within a doping concentration of the rare earth element described above. Specifically, the ytterbium and the erbium atoms included in the perovskite nanocrystal are doped at the doping concentration described above, and the ratio between the ytterbium and the erbium may be 3:7, 4:6, 5:5, 6:4, or 7:3. As a non-limiting example, in the perovskite nanocrystal having a doping concentration of the rare earth element of 6%, the ratio between the ytterbium and the erbium may be 5:5, that is, the ytterbium may be doped at 3% and the erbium may be doped at 3%.

The present invention provides a method for preparing a perovskite nanocrystal including: (S1) adding a first perovskite precursor, a first rare earth salt, a second rare earth salt, and a ligand precursor to an organic solvent and mixing them; (S2) adding a second perovskite precursor to the organic solvent; and (S3) cooling the organic solvent to prepare a perovskite nanocrystal, wherein the first rare earth salt and the second rare earth salt independently of each other include rare earth elements which are the same or different from each other, and the organic solvents in (S1) and (S2) are independently of each other continuously heated to a certain temperature.

In the description of the method for preparing a perovskite nanocrystal, since the rare earth element, the perovskite nanocrystal, and the like are the same or similar as described above for the perovskite nanocrystal, the method for preparing a perovskite nanocrystal according to the present invention includes all of the descriptions of the perovskite nanocrystal above.

Hereinafter, the method for preparing a perovskite nanocrystal of the present invention will be described in more detail.

According to an exemplary embodiment, the rare earth elements included in the first rare earth salt and the second rare earth salt may be independently of each other one or more selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). As described above for the perovskite nanocrystal, the first rare earth salt and the second rare earth salt may include the rare earth element, and the rare earth element included in the first rare earth salt and the second rare earth salt may be the same as or different from each other, but for performing the upconversion photoluminescence, it may be preferred that the rare earth element included in the first rare earth salt and the second rare earth salt includes rare earth elements different from each other.

According to an exemplary embodiment, an anion included in the first rare earth salt and the second rare earth salt may independently of each other include a halogen anion. Specifically, the first rare earth salt and the second rare earth salt may independently of each other include a halogen anion of the same type as X in Chemical Formula 1 to provide the X ion when preparing the perovskite nanocrystal. As a non-limiting example, when the perovskite crystal is CsPbBr_{1.8}Cl_{1.2}, the first rare earth salt may be one or more selected from the group consisting of ytterbium chloride (YbCl₃), ytterbium bromide (YbBr₃), erbium chloride (ErCl₃), and erbium bromide (ErBr₃). In addition, the second rare earth salt may be one or more selected from the group consisting of ytterbium chloride (YbCl₃), ytterbium bromide (YbBr₃), erbium chloride (ErCl₃), and erbium bromide (ErBr₃). The anion included in the first rare earth salt and the second rare earth salt may be appropriately selected depending on the chemical species of the perovskite nanocrystal and prepared.

According to an exemplary embodiment, the total number of moles of the rare earth element included in the first rare earth salt and the second rare earth salt may be 3 to 9% of the number of moles of cations included in the first perovskite precursor. As described above for the perovskite nanocrystal, the rare earth element included in the perovskite nanocrystal may be substituted at a ratio of 1% or more, 2% or more, 3% or more, 4% or more, or 5% or more and as the upper limit, may be substituted at a ratio of 30% or less, 20% or less, 15% or less, 9% or less, or 7% or less, when the number of atoms of the B element in Chemical Formula 1 is 100%, and specifically, the substituted rare earth element may be substituted at a ratio of 1 to 30%, 2 to 20%, 3 to 15%, 4 to 9%, or 5 to 7% of the B atom. Thus, the total number of moles of the rare earth elements included in the first rare earth salt and the second rare earth salt is adjusted to the ratio described above and may be doped on the perovskite nanocrystal.

According to an exemplary embodiment, the first perovskite precursor may be a compound satisfying the following Chemical Formula 2:

BX₂ (Chemical Formula 2)
wherein B is a divalent metal cation, and X is a halogen anion which is I⁻, Br⁻, Cl⁻, or a combination thereof.

B and X in Chemical Formula 2 may be the same chemical species as B and X of the perovskite nanocrystal of Chemical Formula 1. The first perovskite precursor satisfying Chemical Formula 2 may be reacted with the second perovskite precursor described later and crystallized to prepare the perovskite nanocrystal satisfying Chemical Formula 1. As a non-limiting example, B in Chemical Formula 2 may include lead (Pb).

According to an exemplary embodiment, the second perovskite precursor may be a compound satisfying the following Chemical Formula 3:

AL (Chemical Formula 3)
wherein A is one or more monovalent cations selected from the group consisting of monovalent alkylammonium-based cations; monovalent amidinium-based cations; Li⁺; Na⁺; K⁺; Rb⁺; Cs⁺; Fr⁺; Cu(I)⁺; Ag(I)⁺; Au(I)⁺; and a combination thereof, and L is a monovalent anion including a carboxyl group and a carbon chain.

A in Chemical Formula 3 may be the same chemical species as A of the perovskite nanocrystal of Chemical Formula 1 described above. The second perovskite precursor satisfying Chemical Formula 3 may be reacted with the first perovskite precursor satisfying Chemical Formula 2 and crystallized to prepare a perovskite nanocrystal including an ABX₃ perovskite nanocrystal and a perovskite nanocrystal including an L ligand of Chemical Formula 3.

According to an exemplary embodiment, A in Chemical Formula 3 may be a cesium (Cs) monovalent cation.

In addition, according to an exemplary embodiment, L in Chemical Formula 3 may be an oleic acid monovalent anion. Therefore, as a non-limiting example, the second perovskite precursor may be cesium oleate.

According to an exemplary embodiment, the ligand precursor may be one or more selected from the group consisting of an amine ligand, an organic acid, a phosphine ligand, a sulfide ligand, a bidentate ligand, and a tridentate ligand.

Specifically, the amine ligand may be an amine having a linear or branched C5-C20 hydrocarbon chain including C—C or C═C. As a non-limiting example, it may be hexylamine, octylamine, decylamine, dodecylamine, oleylamine, and the like, but the present invention is not limited thereto.

In addition, specifically, the organic acid may be a linear or branched C5-C20 hydrocarbon acid including C—C or C═C. As a non-limiting example, it may be hexanoic acid, octanoic acid, decanoic acid, undecanoic acid, lauric acid, hexadecenoic acid, octadecanoic acid, oleic acid, and the like, but the present invention is not limited thereto.

In addition, specifically, the phosphine ligand may be trioctylphosphine, trioctylphosphine oxide, and the like, but the present invention is not limited thereto.

In addition, specifically, the sulfide ligand may be 1,2-ethanedithiol, and also, may be 3-(N,N-dimethyloctadecylamonio)propanesulfonate which is an amphiphilic material and the like, but the present invention is not limited thereto.

According to an exemplary embodiment, the ligand precursor may be one or more selected from the group consisting of hexylamine, octylamine, decylamine, dodecylamine, oleylamine, hexanoic acid, octanoic acid, decanoic acid, undecanoic acid, lauric acid, hexadecenoic acid, octadecanoic acid, oleic acid, trioctylphosphine, trioctylphosphine oxide, 1,2-ethanedithiol, 3-(N,N-dimethyl(octadecyl)ammonio)propane-1-sulfonate, and a combination thereof. The ligand precursor may be any chemical species which allows the perovskite nanocrystal to be present in a colloidal form in a solution with L of Chemical Formula 3, in addition to the chemical species described above. As a favorable example, the ligand precursor may be an oleic acid which is the same chemical species as L of Chemical Formula 3.

According to an exemplary embodiment, a temperature of the organic solvent in (S1) and (S2) may be independently of each other 30 to 250° C. Specifically, the organic solvent in (S1) and (S2) may be independently of each other maintained at 30° C. or higher, 40° C. or higher, 50° C. or higher, 60° C. or higher, or 70° C. or higher, and as the upper limit, maintained at 300° C. or lower, 250° C. or lower, 200° C. or lower, 180° C. or lower, or 150° C. or lower. Specifically, the organic solvent in (S1) and (S2) may be independently of each other maintained at 30 to 300° C., 40 to 250° C., 50 to 200° C., 60 to 180° C., or 70 to 150° C.

According to an exemplary embodiment, the temperature of the organic solvent in (S1) and (S2) is maintained constant at the same temperature within the temperature range described above, and may be a factor which determines the size of the perovskite nanocrystal while performing cooling in (S3) later. As a favorable example, the temperature of the organic solvent in (S1) and (S2) may be 180 to 220° C.

According to an exemplary embodiment, the temperature of the organic solvent in (S1) and (S2) may be different from each other within the range described above. As a non-limiting example, the temperature of the organic solvent in (S1) may be 120° C., and the temperature of the organic solvent in (S2) may be 200° C. The temperature of the organic solvent in (S1) may be appropriately selected within the temperature range described above to appropriately select a temperature at which a solute is dissolved well, and the temperature of the organic solvent in (S2) may be appropriately selected in a range in which the nucleus of the nanocrystal may grow well, considering (S3) to be performed later.

According to an exemplary embodiment, the cooling in (S3) may be cooling the organic solvent to 25° C. The cooling in (S3) may be cooling the temperature of the organic solvent which is constantly heated in (S1) and (S2) described above to the temperature of the organic solvent in (S1) and (S2) or lower. The temperature of the organic solvent in (S3) may be 40° C. or lower, 30° C. or lower, 25° C. or lower, or 20° C. or lower, and as the lower limit, −10° C. or higher, 0° C. or higher, 5° C. or higher, or 10° C. or higher. Specifically, the temperature of the organic solvent in (S3) may be −10 to 40° C., 0 to 30° C., 5 to 25° C., or 10 to 20° C. The temperature of the organic solvent in (S3) may be lower than the temperature of the organic solvent in (S1) and (S2), and the temperature of the organic solvent in (S1), (S2), and (S3) may be appropriately selected to adjust the size of the perovskite nanocrystal and the like.

The present invention provides an anti-counterfeiting ink, and the anti-counterfeiting ink may include the perovskite nanocrystal described above. In describing the anti-counterfeiting ink, since the anti-counterfeiting ink includes the perovskite nanocrystal described above, the anti-counterfeiting ink according to the present invention includes all of the descriptions above for the perovskite nanocrystal and the method for preparing the perovskite nanocrystal.

Hereinafter, the anti-counterfeiting ink of the present invention will be described in detail.

According to an exemplary embodiment, the anti-counterfeiting ink includes the perovskite nanocrystal and may show both upconversion photoluminescence and photoluminescence. The upconversion photoluminescence may have a luminescence peak at 542±10 nm by irradiation of light at 980±10 nm, and the photoluminescence may have a luminescence peak at 440±10 nm by irradiation of light at 365±10 nm, as described above as a non-limiting example. Herein, the photoluminescence may be confirmed with the naked eye, but the upconversion photoluminescence may not be confirmed by the naked eye by humans and may be confirmed only from a photoluminescence spectrum. The anti-counterfeiting ink may be used in the anti-counterfeiting technology, using the multiple photoluminescence characteristics.

The anti-counterfeiting ink may have various upconversion photoluminescence peaks and photoluminescence peaks depending on the chemical species of the perovskite crystal and the rare earth element included in the perovskite nanocrystal, and may be used as an anti-counterfeiting ink by appropriately selecting the chemical species. As a non-limiting example, the anti-counterfeiting ink may be used by printing the ink on banknotes, but the present invention is not limited thereto.

Hereinafter, the examples and the experimental examples will be illustrated in detail. However, the examples and the experimental examples described later are only illustrative of some, and the technology described in the present specification is not construed as being limited thereto.

### (Example 1)—Method for Preparing CsPbCl_{1.8}Br_{1.2}:Yb, Er Nanocrystal

0.69 g (1.88 mmol) of lead bromide (PbBr₂), 0.3643 g (0.94 mmol) of ytterbium chloride (YbCl₃), 0.3589 g (0.94 mmol) of erbium chloride (ErCl₃), 8 ml of oleic acid and 8 ml of oleylamine were added to 50 ml of octadecene which was constantly heated to 120° C. to prepare a mixed solution. The mixed solution was prepared under an argon (Ar) atmosphere and maintained constantly at 120° C.

After the temperature of the mixed solution was raised to 200° C., 1 ml of cesium oleate was rapidly injected. 1 minute after the injection, the mixed solution was cooled to 0° C. and stirred to prepare a perovskite nanocrystal.

The perovskite nanocrystal was dispersed at a concentration of 10 mg/ml in cyclohexane to prepare a colloidal perovskite nanocrystal solution.

In addition, 1 ml of the colloidal perovskite nanocrystal solution and 4 ml of glycerol were mixed to prepare an anti-counterfeiting ink.

### (Comparative Example 1)—Method for Preparing CsPbCl_{1.8}Br_{1.2}:Yb Nanocrystal

A perovskite nanocrystal and an anti-counterfeiting ink were prepared in the same manner as in Example 1, except that 0.69 g (1.88 mmol) of lead bromide (PbBr₂), 0.7286 g (1.88 mmol) of ytterbium (YbCl₃), 8 ml of oleic acid, and 8 ml of oleylamine were added to 50 ml of octadecene which was constantly heated to 120° C. to prepare a mixed solution.

### (Comparative Example 2)—Method for Preparing CsPbCl_{1.8}Br_{1.2} Nanocrystal

A perovskite nanocrystal and an anti-counterfeiting ink were prepared in the same manner as in Example 1, except that 0.69 g (1.88 mmol) of lead bromide (PbBr₂), 0.7842 g (2.82 mmol) of lead chloride (PbCl₂), 8 ml of oleic acid, and 8 ml of oleylamine were added to 50 ml of octadecene which was constantly heated to 120° C. to prepare a mixed solution.

### (Comparative Example 3)—Method for Preparing NaYF₄:Yb, Er Nanocrystal

1.250 g of ytterbium acetate, 0.025 g of erbium acetate, and 18 ml of oleic acid were added to 45 ml of octadecene to prepare a mixed solution. The mixed solution was prepared at room temperature under an argon (Ar) atmosphere. 2.112 g of sodium oleate was added to the mixed solution and stirring was performed for 10 minutes.

0.444 g of ammonium fluoride (NH₄F) and 22.5 mg of sodium hydroxide (NaOH) were dissolved in 30 ml of methanol to prepare an addition solution.

The addition solution was added dropwise to the mixed solution, stirring was performed for 30 minutes, and after the stirring was completed, the temperature of the mixed solution was heated to 100° C. to remove methanol included in the mixed solution.

The mixed solution was treated at 300° C. for 1 hour and the temperature was lowered to room temperature to prepare an erbium-doped fluorinated yttrium-sodium (NaYF₄:Yb, Er) nanocrystal.

The nanocrystal was dispersed in cyclohexane to prepare a colloidal nanocrystal solution.

### Experimental Example 1

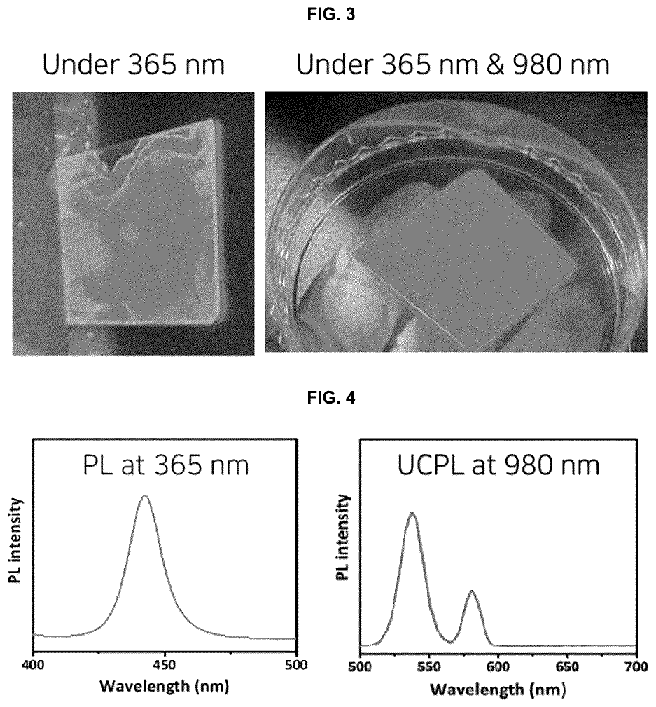

The anti-counterfeiting ink according to Example 1 was spin coated on a glass substrate having a size of 2.5 cm×2.5 cm, and the photoluminescence of the anti-counterfeiting ink was measured and is shown in FIG. 3 (optical image) and FIG. 4 (photoluminescence peak).

Referring to FIG. 3, it was confirmed that the perovskite nanocrystal according to Example 1 showed blue photoluminescence when light at 365 nm was irradiated with single light stimulation (left side of FIG. 3). In addition, it was confirmed that the perovskite nanocrystal according to Example 1 also showed blue photoluminescence when double light stimulation at 365 nm and 980 nm was irradiated (right side of FIG. 3), and thus, there was no visual difference between the single light stimulation and the double light stimulation.

However, referring to FIG. 4, it was confirmed that the double light stimulation was shown in the luminescence peak at 542 nm (right side of FIG. 4) as well as the luminescence peak at 440 nm (left side of FIG. 4). The luminescence peak at 542 nm was not shown by the single light stimulation at 365 nm. Therefore, it was confirmed that the perovskite nanocrystal according to Example 1 showed both photoluminescence and upconversion photoluminescence from the double light stimulation.

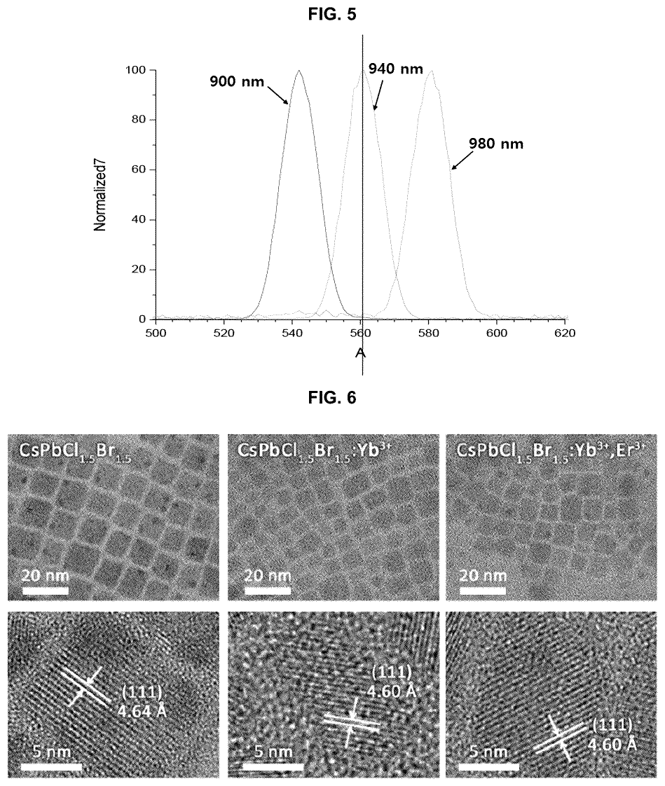

In addition, it was confirmed that the luminescence peak at 580 nm in the right image of FIG. 4 was a scattering peak of which the wavelength moved together proportionally when the wavelength of excitation light was adjusted to 900 nm, 940 nm, and 980 nm, and was not the luminescence peak occurring in the perovskite nanocrystal according to Example 1, and the results of scattering peak occurrence are shown in FIG. 5. Referring to FIG. 5, it was confirmed that the luminescence peak occurred at a position of 540 nm when light at 900 nm was irradiated and the luminescence peaks when lights at 940 nm and 980 nm were irradiated gradually moved to 560 nm and 580 nm.

### Experimental Example 2

The perovskite nanocrystals according to Example 1 (CsPbCl_{1.8}Br_{1.2}: Yb,Er), Comparative Example 1 (CsPbCl_{1.8}Br_{1.2}:Yb) and Comparative Example 2 (CsPbCl_{1.8}Br_{1.2}) were photographed using a transmission electron microscope (TEM) and are shown in FIG. 6.

It was confirmed that the upper and lower left sides of FIG. 6 (Comparative Example 2) had a (111) lattice constant of 4.64 Å, but the upper and lower middle sides of FIG. 6 (Comparative Example 1) and the upper and lower right sides of FIG. 6 (Example 1) had a (111) lattice constant of 4.60 Å, in which ytterbium (Yb) and erbium (Er) were doped well.

### Experimental Example 3

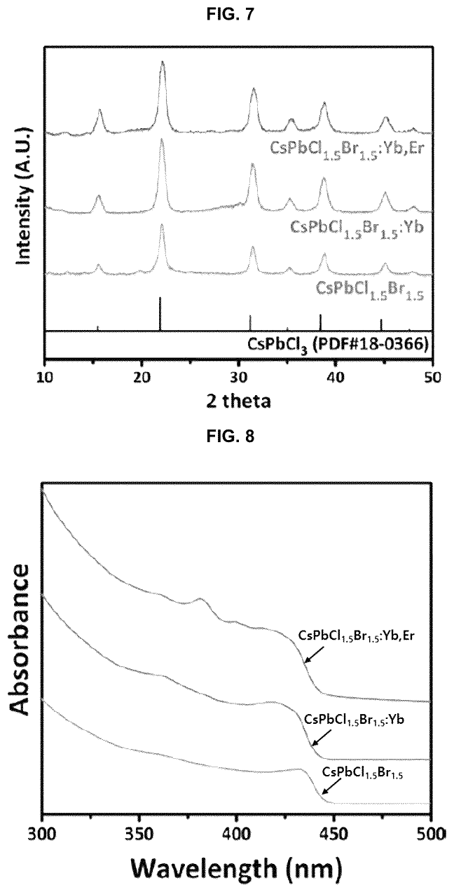

The perovskite nanocrystals according to Example 1 (CsPbCl_{1.8}Br_{1.2}: Yb,Er), Comparative Example 1 (CsPbCl_{1.8}Br_{1.2}:Yb), and Comparative Example 2 (CsPbCl_{1.8}Br_{1.2}) were analyzed by X-ray diffraction, and the results are shown in FIG. 7. Standard tetragonal CsPbCl₃ (PDF #18-0336) is shown in the bottom of FIG. 7.

Referring to FIG. 7, it was confirmed that all of the perovskite nanocrystals according to Example 1, Comparative Example 1, and Comparative Example 2 had a perovskite structure well, and their diffraction angles increased at 26=22±0.14° depending on the doping concentration of a rare earth metal.

### Experimental Example 4

Absorbance of the perovskite nanocrystals according to Example 1 (CsPbCl_{1.8}Br_{1.2}: Yb,Er), Comparative Example 1 (CsPbCl_{1.8}Br_{1.2}:Yb) and Comparative Example 2 (CsPbCl_{1.8}Br_{1.2}) was measured using a UV-Vis spectrophotometer and is shown in FIG. 8. It was confirmed that the absorbance peaks of perovskite were the same, but peaks due to rare earth element doping were further produced, and from the further produced peaks, it was confirmed that the rare earth element was doped well.

### Experimental Example 5

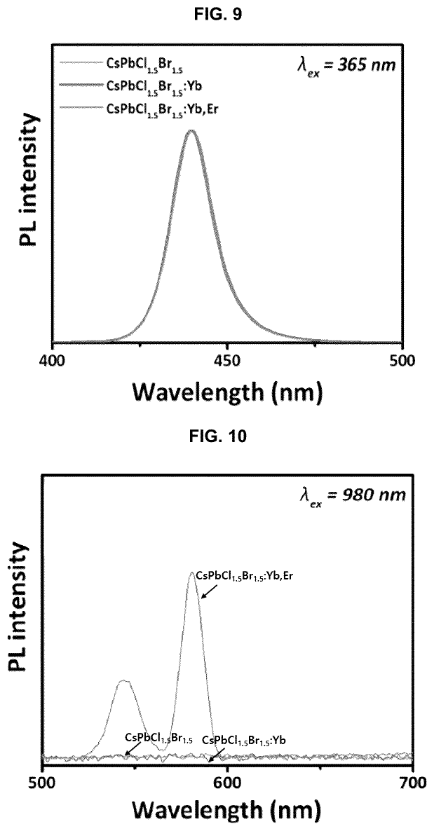

The luminescence peaks of the perovskite nanocrystals according to Example 1 (CsPbCl_{1.8}Br_{1.2}: Yb,Er), Comparative Example 1 (CsPbCl_{1.8}Br_{1.2}:Yb), and Comparative Example 2 (CsPbCl_{1.8}Br_{1.2}) under a light source at 365 nm were measured and are shown in FIG. 9.

In addition, the luminescence peaks of the perovskite nanocrystals according to Example 1 (CsPbCl_{1.8}Br_{1.2}: Yb,Er), Comparative Example 1 (CsPbCl_{1.8}Br_{1.2}:Yb), and Comparative Example 2 (CsPbCl_{1.8}Br_{1.2}) under a light source at 980 nm were measured and are shown in FIG. 10.

It was confirmed that all of the perovskite nanocrystals according to Example 1, Comparative Example 1, and Comparative Example 2 had the luminescence peak at 440 nm under a light source at 365 nm.

However, it was confirmed that only the perovskite nanocrystal according to Example 1 had a luminescence peak at 542 nm under a light source at 980 nm. Therefore, it was confirmed that only the perovskite nanocrystal according to Example 1 showed upconversion photoluminescence (UCPL).

It was confirmed that the luminescence peak at a position of 580 nm of FIG. 10 was a scattering peak which moved together when the excitation light was adjusted to 900 nm, 940 nm, and 980 nm, and was not a peak occurring in the perovskite nanocrystal according to Example 1.

### Experimental Example 6

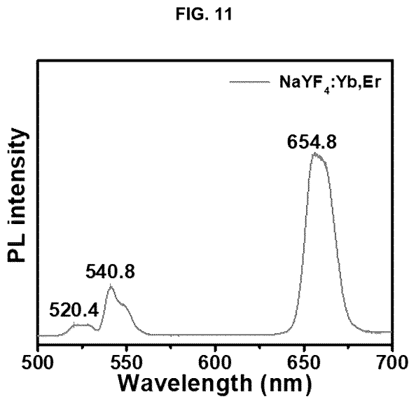

The luminescence peak of the nanocrystal according to Comparative Example 3 (NaYF₄:Yb, Er) was measured and is shown in FIG. 11.

As confirmed in FIGS. 9 and 10, the nanocrystal according to Comparative Example 3 showed upconversion photoluminescence using ytterbium and erbium, but had three upconversion photoluminescence peaks at positions of 522 nm, 542 nm, and 655 nm. However, referring to FIG. 10, it was confirmed that the perovskite nanocrystal according to Example 1 had a single upconversion photoluminescence peak at a position of 542 nm.

### Experimental Example 7

Doping content ratios of the perovskite nanocrystals according to Example 1 (CsPbCl_{1.8}Br_{1.2}: Yb,Er), Comparative Example 1 (CsPbCl_{1.8}Br_{1.2}:Yb), and Comparative Example 2 (CsPbCl_{1.8}Br_{1.2}) were analyzed by inductively coupled plasma-mass spectrometry and are shown in the following Table 1:

TABLE 1

| | Pb | Yb | Er |
|---|---|---|---|
| Example 1 | 93.22% | 3.30% | 3.48% |
| Comparative Example 1 | 96.63% | 3.37% | — |
| Comparative Example 2 | 100% | — | — |

Referring to Table 1, it was confirmed that the doping content ratio of the perovskite nanocrystal according to Example 1 was about 3.3% in both ytterbium (Yb) and erbium (Er).

The perovskite nanocrystals according to the present invention independently of each other perform upconversion photoluminescence and photoluminescence to independently of each other show multiple emissions from multiple light stimulation.

The perovskite nanocrystal according to the present invention may show characteristics of photoluminescence in the perovskite crystal; and upconversion photoluminescence which is sensitized and emitted in the rare earth metal, and the two characteristics may be independently adjusted at the same time. Thus, the luminous lifetime and the switching speed of a perovskite quantum dot may be improved.

The perovskite nanocrystal according to the present invention may be used in the optical device field, in particular, the anti-counterfeiting field.

Hereinabove, although the present specification has been described by specified matters and specific exemplary embodiments, they have been provided only for assisting in the entire understanding of the present invention. Therefore, the present invention is not by the specific matters limited to the exemplary embodiments. Various modifications and changes may be made by those skilled in the art to which the present invention pertains from this description. Therefore, the spirit described in the present specification should not be limited to the above-described exemplary embodiments, and the following claims as well as all modified equally or equivalently to the claims are intended to fall within the scope and spirit of the specification.

What is claimed is:

1. A perovskite nanocrystal, wherein the perovskite nanocrystal satisfying the following Chemical Formula 1 is doped by substituting a part of a B atom in Chemical Formula 1 with one or more divalent or trivalent cations selected from the group consisting of rare earth elements, and the perovskite nanocrystal shows both upconversion photoluminescence and photoluminescence:
ABX₃ (Chemical Formula 1)
wherein A is one or more selected from the group consisting of monovalent alkylammonium-based cations; monovalent amidinium-based cations; Li⁺; Na⁺; K⁺; Rb⁺; Cs⁺; Fr⁺; Cu(I)⁺; Ag(I)⁺; Au(I)⁺; and a combination thereof, B is a divalent metal cation, and X is a halogen anion which is I⁻, Br⁻, Cl⁻, or a combination thereof.

2. The perovskite nanocrystal of claim 1, wherein the rare earth element is one or more selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

3. The perovskite nanocrystal of claim 1, wherein the substituted and doped rare earth element includes ytterbium trivalent cation (Yb³⁺) and erbium trivalent cation (Er³⁺).

4. The perovskite nanocrystal of claim 1, wherein the B atom in Chemical Formula 1 included in the perovskite nanocrystal is a lead (Pb²⁺) cation.

5. The perovskite nanocrystal of claim 1, wherein the photoluminescence has a luminescence peak in a wavelength band of 420 to 470 nm, when a wavelength of incident light is 365±10 nm.

6. The perovskite nanocrystal of claim 1, wherein the upconversion photoluminescence has a luminescence peak in a wavelength band of 520 to 580 nm, when a wavelength of incident light is 980±10 nm.

7. The perovskite nanocrystal of claim 1, wherein full widths at half maximum (FWHM) of the luminescence peaks of the photoluminescence and the upconversion photoluminescence are independently of each other 10 to 20 nm.

8. The perovskite nanocrystal of claim 1, wherein a doping concentration is 3% to 9% of an atom of the rare earth element, based on the total number of B atoms per lattice of the perovskite nanocrystal.

9. The perovskite nanocrystal of claim 3, wherein a ratio between the ytterbium (Yb³⁺) and the erbium (Er³⁺) included in the perovskite nanocrystal is 3:7 to 7:3.

10. A method for preparing a perovskite nanocrystal, the method comprising:
(S1) adding a first perovskite precursor, a first rare earth salt, a second rare earth salt, and a ligand precursor to an organic solvent and mixing them;
(S2) adding a second perovskite precursor to the organic solvent; and
(S3) cooling the organic solvent to prepare a perovskite nanocrystal,
wherein the first rare earth salt and the second rare earth salt independently of each other include rare earth elements which are the same or different from each other, and
the organic solvents in (S1) and (S2) are independently of each other continuously heated to a certain temperature.

11. The method for preparing a perovskite nanocrystal of claim 10, wherein temperatures of the organic solvents in (S1) and (S2) are independently of each other 30 to 250° C.

12. The method for preparing a perovskite nanocrystal of claim 10, wherein the rare earth elements included in the first rare earth salt and the second rare earth salt are independently of each other one or more selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

13. The method for preparing a perovskite nanocrystal of claim 10, wherein the rare earth element included in the first rare earth salt is ytterbium (Yb) and the rare earth element included in the second rare earth salt is erbium (Er).

14. The method for preparing a perovskite nanocrystal of claim 10, wherein a total number of moles of the rare earth elements included in the first rare earth salt and the second rare earth salt is 3 to 9% of the number of moles of cations included in the first perovskite precursor.

15. The method for preparing a perovskite nanocrystal of claim 10, wherein the first perovskite precursor is a compound satisfying the following Chemical Formula 2:
BX₂ (Chemical Formula 2)
wherein B is a divalent metal cation, and X is a halogen anion which is I⁻, Br⁻, Cl⁻, or a combination thereof.

16. The method for preparing a perovskite nanocrystal of claim 15, wherein B in Chemical formula 2 includes lead (Pb).

17. The method for preparing a perovskite nanocrystal of claim 10, wherein the second perovskite precursor is a compound satisfying the following Chemical Formula 3:
AL (Chemical Formula 3)
wherein A is one or more monovalent cations selected from the group consisting of monovalent alkylammonium-based cations; monovalent amidinium-based cations; Li⁺; Na⁺; K⁺; Rb⁺; Cs⁺; Fr⁺; Cu(I)⁺; Ag(I)⁺; Au(I)⁺; and a combination thereof, and L is a monovalent anion including a carboxyl group and a carbon chain.

18. The method for preparing a perovskite nanocrystal of claim 17, wherein A in Chemical Formula 3 is a cesium (Cs) monovalent cation.

19. The method for preparing a perovskite nanocrystal of claim 17, wherein L in Chemical formula 3 is an oleic acid monovalent anion.

20. An anti-counterfeiting ink comprising the perovskite nanocrystal of claim 1.
